(19) United States
(12) Patent Application Publication
(10) Pub. No.: US 2005/0066537 A1
(43) Pub. Date: Mar. 31, 2005

(54) Abatement of contamination present in structures

(76) Inventors: Alfred A. Kahner III, Saugus, CA (US); Stephen W. Roy, Valencia, CA (US); James L. Unmack, Rancho Palos Verdes, CA (US)

Correspondence Address: LIU & LUI, Suite 1100, 811 West 7th Street, Los Angeles, CA, 90017, US

(21) Appl. No.: 10/676,908

(22) Filed: Sep. 30, 2003

(51) Int. Cl. F26B 19/00

(52) U.S. Cl. 34/90

(57) ABSTRACT

A system and method for controlling contamination of harmful substances such as fungi in structures, which comprises the aspects of controlled evacuation of contamination in cavities within a structure, removal of the source of contamination at hard-to-reach structures in a substantially non-destructive manner, and treatment of contaminated surfaces to prevent re-contaminations. Controlled evacuation may be facilitated by creating a pressure gradient in a contaminated cavity, such as by drawing air through one or more inlets and outlets created in the structure while maintaining relatively safe containment of the contaminated air. The drawn air may be filtered to remove contaminants. The substantially non-destructive source removal process may include the use of biocide or microwaves to abate the mold colony in hard-to-reach structures. The surface treatment process comprises the application of a lock-down material to prevent re-contaminations.

### BACKGROUND OF THE INVENTION

1. Field of the Invention

The present invention relates to the abatement of undesirable substances present in structures, and particularly to abatement in a substantially non-destructive manner with respect to the structures, and more particularly to the abatement of harmful organisms present in cavities in structures.

2. Description of Related Art

Molds are natural decomposers of organic materials such as wood, plants and animals and exist throughout our environment. Mold spores can enter a building through the air or on people, animals and objects that are brought into the building. When the mold spores settle on an area where they can find sufficient quantity of nutrients, water and favorable temperatures, they can quickly grow and contaminate this area of the building. Nutrients for mold are present in dead organic material such as wood, paper or fabrics; molds can also derive nutrients from some synthetic products such as paints and adhesives. People and animals can suffer from a variety of mold-related health problems including infection, asthma and allergy. Therefore, mold abatement is an important consideration in maintaining the health of the building's occupant.

Mold abatement may require elimination of the contributing environmental factors, such as by fixing a leaky pipe to permanently remove a water source, and source removal, such as killing a mold colony until it no longer poses a health risk according to acceptable levels. However, the source removal process can stress the mold colony, causing it to release its spores. These spores can cause further respiratory health problems for the building's occupants. In addition, these spores can disperse and re-establish themselves in either the same or a new location once the threat is removed. When a colony is threatened, it can produce powerful chemicals called “mycotoxins” or microbial volatile organic compounds (MVOC) that can induce illness in people and animals. Care must be taken to minimize the effect of MVOC emission through either exhaustion or exfiltration. During source removal, dead mold cells should be removed or contained because the dead cells can cause health problems to humans.

One approach to removing a mold colony is to wash the infected area with soapy water or a disinfecting agent, rinse and allow the area to dry. However, this method is only effective if the mold colony resides on an easily accessible hard surface. Otherwise, this method is not applicable for hard to reach or confined areas, or concealed structures such as cavities inside building structures.

An alternate approach is to remove all the mold-contaminated structures such as the drywall and other wall attachments. This approach requires engineered isolation techniques to prevent inadvertent dispersal of mold spores and MVOC, and is thereby disruptive for both owners and occupants, and may not be economically feasible for some situation. In addition, this approach also requires the replacement of the removed structures, which makes this process an expensive alternative. The drawbacks of this approach are exacerbated for hard to reach mold-contaminated areas, where this approach requires the removal and replacement of uncontaminated structures to reach the mold-contaminated areas.

Still another alternate approach is to use microwave generators to heat and kill biological agents in hard to reach areas (see, U.S. Pat. No. 5,968,401 to Roy). However, thermal disturbance of the mold colony can cause sporulation and MVOC emission, which would present danger of reoccurrence of mold contamination and increased respiratory problem for the building's occupants.

Yet another alternate approach is to apply biocide onto the contaminated surfaces. Thus far, such approach alone is inadequate for treating hard to reach locations. In addition, using biocide alone may lead to health problems associated with by-products of such source removal process.

None of the prior art mold abatement processes is adequate in preventing further contamination during source removal or re-contamination after completion of source removal. What is needed is a novel method for the abatement of mold contaminations in cavities of structures with minimum disruption to normal activities of the building's occupants, in a manner that avoids the complete removal and replacement of contaminated structures, which contains the unhealthy by-products that occur when a mold colony is disturbed by source removal, and which prevents mold re-contamination.

### SUMMARY OF THE INVENTION

The present invention overcomes the drawbacks of the prior art by presenting an improved method for abatement of contamination by undesirable or harmful substances present in structures, which more completely removes the source of the contamination, and prevents re-contaminations. More particularly, the present invention comprises the aspects of controlled evacuation of contamination (e.g., comprising airborne spores and MVOC) in cavities within a structure, economically controlling hard-to-reach contaminated interior surfaces in a substantially non-destructive manner, and treatment of contaminated interior surfaces to reduce the spread and re-contamination of the harmful substances. The cavity may be partially or completely enclosed by permanent, semi-permanent or temporary structures where access is difficult. For example, a cavity may be the space within walls, above ceilings or below floorings.

In one aspect of the present invention, the abatement method of the present invention provides evacuation of the contaminated cavity in a controlled manner to restrict the flow of contaminated air into the ambient environment. The controlled evacuation process may be deployed alone, or in conjunction with the source removal process and/or treatment process below.

In one embodiment, controlled evacuation is facilitated by creating a pressure gradient in the cavity. This pressure gradient may be created by drawing air through one or more outlet openings created in the structure. The drawn air may be cleaned or filtered to remove contaminants such as mold spores and MVOC.

In another embodiment, one or more inlet openings are created in the structure to increase the volume of air that can move through the cavity while still maintaining the relatively safe containment of the contaminated air. Air may be forced into the inlets to increase airflow through the cavity to flush out the contaminated air present in the cavity.

In still another embodiment, a closed loop air cleaning or filtration process is established with respect to the mold-contaminated air in the cavity. Contaminated air is cleaned or filtered and fed back into the cavity in a continuous closed-loop process to remove mold-contaminated air in a controlled manner.

In another aspect of the present invention, the abatement method of the present invention comprises providing a substantially non-destructive approach to removing the source of the contamination in hard-to-reach structures (e.g., the inside of wall structures, or the inside walls of cavities). This source removal process may be deployed alone, or in conjunction with the controlled evacuation processes described above and/or the treatment process below.

In one embodiment, a biocide is sprayed onto the contaminated interior surfaces within the cavity structure. An air pressure gradient may be established in the cavity to facilitate the dispersal of the biocide throughout the cavity. In an alternate embodiment, the contamination may be abated through the use of high frequency radio waves that can penetrate through external structures beyond which the contamination is present.

In a further aspect of the invention, a treatment process is applied to prevent re-contaminations of harmful substances. A lock-down material is applied to prevent dispersal and re-contamination of harmful substances on the cavity walls. The lock-down material provides a stable coating as a barrier on the interior surfaces. An air pressure gradient may be established in the cavity to facilitate the dispersal of the lock-down material throughout the cavity. The lock-down material can be introduced into the cavity in the form of a mist, powder, granule, spray, vapor, foam, fog, gas, liquid, or in other formats or phases. This treatment process may be deployed alone or in conjunction with the controlled evacuation process and/or source removal process above.

In one embodiment, organic, preferably non-carcinogenic, material, such as styrene, butadiene and other substituted ethylene (C═C) monomers may be used as the lock-down material. A barrier is formed when the monomers polymerize on the contaminated surfaces, thus forming a stable coating as a barrier to prevent mold spores and mold cells from leaving the surfaces and from penetrating the treated surfaces.

In another embodiment, an organic adhesive material is used as the lock-down material. Harmful substances remaining on the interior surfaces are bonded to the surfaces by the adhesive and thus, prevented from causing attendant allergen problems.

In yet another aspect of the present invention, the foregoing processes may be applied to an open contaminated structure by modifying the open structure into a closed structure, such as by forming a closure.

### BRIEF DESCRIPTION OF THE DRAWINGS

For a fuller understanding of the invention, reference should be made to the following detailed description read in conjunction with the accompanying drawings. In the following drawings, like reference numerals designate like or similar parts throughout the drawings.

FIG. 1 is a sectional view of a wall, showing a wall cavity within which an air pressure gradient is established, and a microwave generator is applied for mold extermination, in accordance with one embodiment of the present invention.

FIG. 2 is a sectional view of a wall, showing a wall cavity within which an air pressure gradient is established, and a biocide and/or a microwave generator is applied for mold extermination, in accordance with one embodiment of the present invention.

FIG. 3 is a sectional view illustrating the application of the inventive processes for an open structure.

### DETAILED DESCRIPTION OF THE PREFERRED EMBODIMENTS

The present description is of the best presently contemplated mode of carrying out the invention. This description is made for the purpose of illustrating the general principles of the invention and should not be taken in a limiting sense. The scope of the invention is best determined by reference to the appended claims.

The present invention is suitable for abatement of many different types of undesirable (e.g., harmful) substances, in particular harmful organisms, such as saprophytic and parasitic spore-producing organisms and organisms that lack chlorophyll, which may include any form of fungi, including mold, mildew, rust, yeast, mushroom, smut, and any mycotoxins, spores, scents, and byproducts produced and/or released by fungi; bacteria; and any other types of harmful substances that might cause health problems in humans and/or other living beings. “Contamination”, as broadly referred to herein, refers to the presence of such undesirable substances, which may not rise to the level that may result in significant injury, harm or damage to health in humans and other living beings (e.g., at a level deemed to be an infection) and/or to structures, whether noticeable or concealed, and whether or not in reference to applicable health and/or structural criteria.

By way of example and not by limitation, the present invention is described in reference to a mold-contaminated region confined within a wall structure in a building. It is understood that the various aspects of the present invention disclosed herein-below may be applied to other types of structures, including but not limited to constructed structures, natural structures, building structures, fixtures, attachments, sculptures, furniture, permanent, temporary and semi-permanent structures.

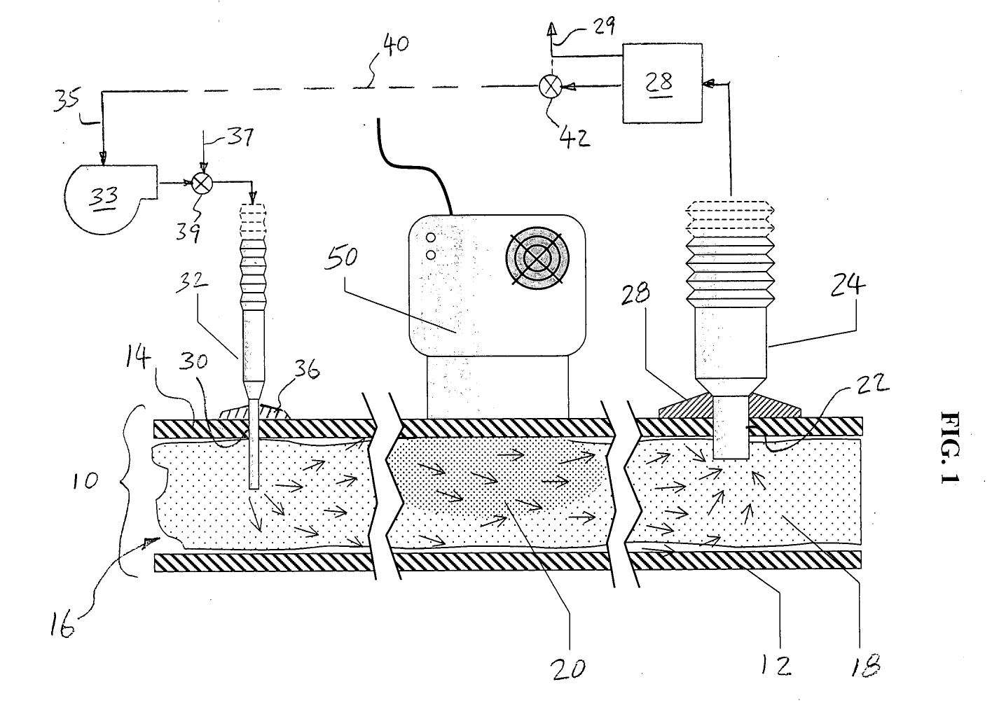

FIG. 1 is a schematic sectional view of a wall 10, within which mold contamination is present. In this example, the wall 10 is of “dry-wall” construction, which comprises two wall panels 12 and 14 defining a void or cavity 16 there-between. The cavity 16 may be filled with insulation materials 18, such as fiberglass. While not shown in FIG. 1, internal structures such as crossbeams and ventilation ducts may be present between the wall panels 12 and 14. To simplify the description herein, the mold-contaminated region 20 is chosen to be present in a section of the wall 10 where such internal structures are not present. It is understood that the present invention is applicable to structures having cavities that are partially or completely enclosed by permanent, semi-permanent or temporary structures where access is difficult. For example, a mold-contaminated cavity may be present in the space within walls, above ceilings or below floorings.

In accordance with the present invention, the mold-contamination in the cavity 16 is abated by removal of mold-contamination and/or treatment to prevent mold re-contaminations.

In one aspect of the present invention, the cavity 16 is evacuated in a controlled manner to restrict the flow of mold-contaminated air trapped between the wall panels 12 and 14. In one embodiment, controlled evacuation of the cavity 16 is facilitated by creating a pressure gradient in the cavity 16. This pressure gradient may be created by drawing air through one or more outlet holes created in the wall panels 12 and 14. Suction is preferred over forcing air into the cavity 16, because movement of contaminated air can be better controlled by suction compared to forced air evacuation.

In the illustrated example in FIG. 1, an outlet hole 22 is drilled in the wall panel 14, at a location that would allow effective evacuation of mold-contaminated air from the mold-contaminated region 20. One can quite easily determine the approximate extent of the mold-contaminated region 20 (or suspected mold-contaminated region 20) from the usual symptoms and results of diagnostic tests known and available to one skilled in the art. For example, as illustrated in FIG. 1, the outlet hole 22 is provided at a location outside the heavily contaminated section of the mold-contaminated region 20. The size of the hole 22 is chosen to fit a suction hose 24, and yet small enough to allow the hole 22 to be easily patched and the wall panel 14 refinished after the evacuation process. For example, the hole 22 may be less than 6 inches in diameter, and preferably 0.5 inches to 1.5 inches in diameter. Depending on the type of insulation material 18, a hole may have to be provided (e.g., by drilling) through the surface of the insulation material 18 to receive the suction hose 24. A pliable seal 28 (e.g., a gasket or a putty) is provided to seal any space between the hole 22 in the wall panel 14 and the suction hose 24.

The suction hose 24 is connected to a suction device 28, such as an industrial vacuum cleaner. The suction device 28 may include one or more filters (not shown) for filtration of the mold-contaminated air drawn through the suction hose 24. For example, the suction device 28 may comprise an industrial vacuum cleaner having a three-stage filtration system, including a pre-filter, a HEPA filter and a charcoal filter (to remove MVOC and odor). Alternatively, appropriate filter elements may be provided along the suction hose 24 upstream of the suction device 28.

In operation, the suction device 28 is activated to create a pressure gradient in the cavity 16. Mold-contaminated air is drawn from the cavity 16, thereby evacuating airborne contaminants such as mold spores and cells and MVOC from the cavity 16. The contaminants are trapped by the filters in the suction device 28. Filtered air may be exhausted to the ambient environment (arrow 29).

For structures that do not allow free flow of air through their internal structures, or in situations where a higher flow of air is desired during the evacuation process, one or more inlet holes may be provided in the wall panels 12 and 14 to facilitate airflow during evacuation to flush out the mold-contaminated air in the cavity 16. In the illustrated example in FIG. 1, an inlet 30 is drilled in the wall panel 14, at a location outside and at the opposite side of the heavily contaminated section of the mold-contaminated region 20, compared to the location of the outlet hole 22. The size of the hole 30 is chosen to be large enough to increase the volume of air that can move through the cavity while still maintaining the relatively safe containment of the contaminated air during evacuation of the cavity 16, and yet small enough to allow the hole 30 to be easily patched and the wall panel 14 refinished after the evacuation process. For example, the hole 30 may be less than 6 inches in diameter, and preferably 0.25 inch to 1.0 inch in diameter.

In operation, the suction device 28 creates a pressure gradient in the cavity 16. Ambient air is drawn into the cavity 16 through the inlet hole 30. The flow of air from the inlet hole 30 across the mold-contaminated region 20 flushes out the mold-contaminated air trapped in the region 20.

Depending on the airflow desired, optionally, air may be forced into the inlets to increase airflow through the cavity to flush out the mold-contaminated air present in the cavity. This may be achieved by fitting an air hose 32 into the inlet hole 30 and pumping ambient air (arrow 35) through the air hose using an external pump 33. Depending on the type of insulation material 18, a hole may have to be provided (e.g., by drilling) through the surface of the insulation material 18 to receive the air hose 32. A pliable seal 36 (e.g., a gasket or a putty) is provided to seal any space between the hole 30 in the wall panel 14 and the air hose 32.

In operation, the rate of air pumped into the cavity 16 and the rate of air evacuated from the cavity 16 should be controlled or balanced to reduce uncontrolled airflow out of the wall 10 through other orifices in the wall panels 12 and 14. In this respect, it may be desired to allow certain flow of ambient air (arrow 37) via a mixing valve 39 to supplement the air delivered by the pump 33.

The flow rate of the air being evacuated would depend in part on the size of the cavity 16, the number of air exchanges required to adequately remove sufficient contaminated air within the cavity 16, and the length of time allocated for the evacuation. The flow rate may range from 2 to 100 CFM (cubic foot per minute). By way of example and not limitation, for a cavity size of about 3.0 cubic feet (e.g., the space between drywall panels in a wall section defined by two 8-foot “2×4” wood beams, spaced at 16 inch apart), it is anticipated that by evacuating at a flow rate of 2 CFM for about 10 minutes, there would be air flow through the cavity that is about 7 times the volume of the cavity, which may be adequate to remove the contaminated air with the cavity to a safe level.

What has been described above is an open loop system. In a further embodiment, a closed loop air cleaning or filtration process is established with respect to the mold-contaminated air in the cavity 16. As illustrated in FIG. 1, the output of the suction device 28 may be coupled to the input of the pump 33 (shown by dotted line 40). Contaminated air is cleaned or filtered and fed back into the cavity 16 in a continuous closed-loop process to remove mold-contaminated air in a controlled manner. A diverter valve 42 may be provided at the outlet of the suction device 28, which may be controlled to divert part of the filtered, evacuated air to the ambient environment. By appropriately controlling the flow rates of the suction device 28 and the pump 33, and the flow settings of the valves 39 and 42, the desired flow of air through the mold-contaminated region 20 in the cavity 16 can be accomplished. While FIG. 1 illustrates separate use of pump 33 and suction device 28, a single blower device may be deployed to provide suction and pressurization functions as required, well within the scope and spirit of the present invention.

In the closed-loop system, some of the air is re-circulated and reused. In this regard, a closed-loop system facilitates the use of an inert gas to flush the cavity 16. Also, in the closed-loop mode, it is possible to maintain an overall lower pressure within the cavity 16 than the external ambient pressure, in addition to the pressure gradient within the cavity 16. The overall lower internal pressure further reduces the escape of contaminated air from the cavity 16 through clearances in the structure, owing to the higher external ambient pressure. Most of the contaminated air within the cavity 16 would be evacuated through the suction hose 24 in a controlled manner.

While the foregoing disclosure referred to a single outlet hole 22 and a single inlet hole 30, a plurality of inlet and outlet holes (not shown) may be provided and distributed about the contaminated region 20, to facilitate even airflow across the contaminated region 20. An air manifold (not shown) may be used to facilitate air suction through the outlets and/or air deliver to the inlets.

In another aspect of the present invention, a substantially non-destructive source removal process is deployed to remove the mold colony present on the surfaces of hard-to-reach or confined structures (e.g., the inside of wall structures, or the inside walls of cavities). This extermination process may be deployed alone, or in conjunction with the controlled evacuation processes described above, and/or the treatment process described below, with or without intermediate steps or processes.

In one embodiment, the mold colony may be abated through the use of high frequency microwaves that can penetrate through external structures beyond which the mold colony is present, and that can eradicate the mold colony. It is desirable to first establish airflow across the mold-contaminated region 20, for example using one of the controlled evacuation processes disclosed above, before application of the microwaves. A microwave generator 50 is placed against the outside of the wall 10 at the vicinity of the mold-contaminated region 20 to ensure maximum exposure. The microwave generator 50 may be selected to operate within the range of 2.0 GHz to 3 GHz, and preferably at 2.4 to 2.5 GHz, and more preferably at 2.45 GHz because this is the ideal frequency for transferring energy to polar molecules such as water molecules that are present at the mold-contaminated region 20. Since mold-contaminated regions generally have higher water content than the surrounding structures, the contaminated regions heat up much faster than the surrounding structures when exposed to 2.45 GHz microwave energy. Microwave generators suitable for use to abate mold colonies may be adapted from the microwave systems designed for exterminating insects, for example as disclosed in U.S. Pat. No. 5,968,401 and U.S. Pat. No. 5,468,938, both issued to Roy, the co-inventor of the present invention, which patents are currently assigned to Microwave Pest Exterminators, Inc.

The necessary exposure time of the microwave energy for an adequate abatement of mold colony varies based on several factors, including the output profile of the microwave generator 50, the material makeup of the targeted region, the species of the mold colony, and the temperature at which adequate abatement of such species can be achieved. For certain substance, a temperature of 160° F. to 200° F. for a period of 10 seconds may be adequate to remove many common species of mold colonies commonly found in dry-wall type structures, without causing cosmetic or physical damage to the surrounding structures. Optionally, a thermometer (e.g., an infrared thermometer; not shown) can be used to measure the surface temperature to make sure that the desired temperature range is achieved and maintained.

In another embodiment of the source removal aspect of the present invention, a biocide that is effective in killing mold is applied to remove a mold colony present in the cavity 16. The biocide is introduced into the cavity 16 in the form of a mist, powder, granule, foam, powder, spray, vapor, fog, liquid, gas, or in other suitable formats or phases in which it can easily spread or propagate through the cavity 16. Because of its denser form compared to air, the format in which the biocide is introduced would be selected depending on the ease of passage of the biocide into the cavity 16. For example, a denser biocide spray would work better for a cavity that is less densely filled with insulation material. Preferably, the biocide is sprayed into the wall cavity 16 after the latter has been evacuated to remove airborne mold-contaminants and/or create at least a pressure gradient is present in the wall cavity 16. However, biocide can be introduced into the wall cavity 16 without first creating a pressure gradient across the wall cavity 16.

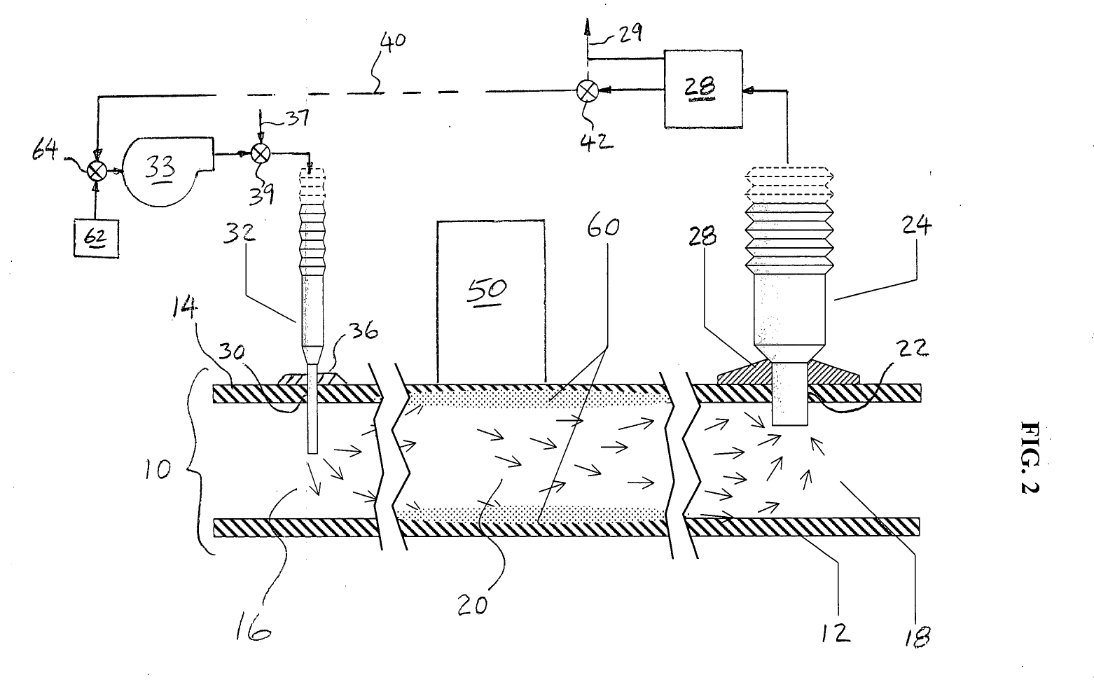

To simplify the disclosure of the biocide embodiment, reference is made to an example of a dry-wall structure without insulation materials within the wall. FIG. 2 is a schematic sectional diagram illustrating a section of the wall 10, without insulation material, as compared to the embodiment shown in FIG. 1. The configuration of the evacuation system may be similar to the system disclosed in reference to FIG. 1. As in the earlier embodiment, a suction hose 24 is inserted into an outlet hole 22 in the wall panel 14. The suction hose 24 is coupled to the input of the suction device 28. Biocide may be injected into the wall cavity 16 by using a similar pump system disclosed in reference to FIG. 1. As in the earlier embodiment, an air hose 32 is inserted into an inlet hole 30 in the wall panel 14. The air hose 32 is coupled to the output of the pump 33. The input of the pump 33 is coupled to a supply source of biocide, for example a reservoir 62, via a mixing valve 64. The output of the suction device 28 may be coupled to the input of the pump 33 in a closed-loop configuration, as in one of the earlier embodiments. More specifically, the output of the suction device 28 may be coupled to the mixing valve 64, which regulates the mixture of the biocide and air to be introduced into the cavity 16. As in the earlier embodiment, a diverter valve 42 may be provided at the output of the suction device 28 to bleed evacuated air into the atmosphere. A mixing valve 39 may be provided at the output of the pump 33 for introducing ambient air into the cavity 16. By appropriately controlling the flow rates of the suction device 28 and the pump 33, and the flow settings of the valves 39, 42 and 64, the desired flow of air and biocide mixture through the mold-contaminated region 20 in the cavity 16 can be accomplished. In this closed-loop system, some of the air is re-circulated and reused.

After the cavity 16 has been evacuated by the suction device 28 to some extent, biocide is introduce via valve 64 and pumped through the air hose 32 into the cavity 16. The biocide is carried by the air stream into the mold-contaminated region 20. The pressure gradient created in the cavity 16 facilitates the dispersal and circulation of the biocide throughout the cavity 16 to come into contact with the mold-contaminated region 20. The biocide kills the mold colony as it comes in contact with the mold-contaminated area. Excess biocide is drawn through the suction hose 24 by the suction device 28. Any contaminant and excess biocide are filtered out by the filtration system associated with the suction device. Some of the biocide could settle onto the mold-contaminated region 20 on the inside of the wall panels 12 and 14, and could also penetrate the wall panels 12 and 14 to more thoroughly remove the mold-contaminated region 20.

The cavity 16 need not be evacuated or completely evacuated of airborne mold contaminants before biocide is introduced. Biocide may also be introduced before evacuation takes place, or concurrently when evacuation is initiated. The amount of ambient air introduced through valve 39 would depend on the concentration of the biocide desired, and the pressure gradient desired to be created in the cavity 16. The system shown in FIG. 2 may be operated in open loop or closed loop mode. In the closed-loop mode, it is possible to maintain an overall lower pressure within the cavity 16 than the external ambient pressure, in addition to the pressure gradient within the cavity 16. The overall lower pressure further reduces the likelihood of any contaminated air escaping from the cavity 16 against the higher external ambient pressure, except via the suction hose 24. The air circulation within the closed-loop system may be set at below external ambient pressure by bleeding air into the ambient environment, before biocide is introduced into the cavity 16. Alternatively, the evacuation or contaminants can take place in a closed loop mode, and biocide is introduced via the valve 64 in an open loop mode (i.e., with the return path 40 opened).

The flow rate for introducing biocide could be similar to the flow rate of the controlled evacuation of the cavity. For example, as noted before, for a 3 cubic-foot cavity, at a flow rate of about 2 CFM for about 10 minutes, there would be enough flow volume passing through the cavity that amounts to 7 times the cavity volume.

Biocides for treatment of mold-contaminated surfaces may include organic or inorganic substances as active ingredients, which may be divided into four general categories: (a) oxidizers, (b) surfactants, (c) toxic metal donors, and (d) metabolic toxins. Examples of oxidizers include bromine, N-bromoacetamide, 3-bromo-1-chloro-5,5-dimethylhydantoin, hydrogen peroxide, hypochlorite bleach solution, iodine, N-bromoacetamide, and ozone. Examples of surfactants include lauryl pyridinium chloride, quaternary ammonium salts, quaternary ammonium solutions, higher molecular weigh alcohols, and d-limonene. Examples of toxic metal donors include borax (sodium tetraborate decahydrate), boric acid, calomel (mercurous chloride), copper hydroxide, copper sulfate, maneb, mancozeb, sulfur, and zineb. Examples of metabolic poisons include benomyl, captan, captafol, cyanides, sulfides, and streptomycin. Other substances, compounds and elements falling within the general categories or otherwise compatible could be used, and is well within the scope of the present invention.

As a specific example of a commercially available biocide suitable for use in the inventive abatement process, TIM-BOR® distributed by U.S. Borax Inc., contains the active ingredient Disodium Octoborate Tetrahydrate, which is another example of a toxic metal donor.

To further facilitate source removal at the mold-contaminated region 20 in the cavity 16, in addition, a microwave generator 50 may be used to apply microwave energy to the mold-contaminated region, in a similar manner as described above in reference to FIG. 1.

The source removal process described above does not have to immediately follow the evacuation process described earlier. Intermediate steps or processes may be deployed without departing from the scope and spirit of the invention. While the source removal process has been described above in conjunction with the controlled evacuation process, in another embodiment, source removal may be deployed without first evacuating the contaminated air from the cavity. Further, the evacuation process and the source removal process may be carried out concurrently, without having to wait for completion of one process to being the other.

In a further aspect of the invention, a treatment process is applied to contaminated surfaces to prevent re-contamination and to inhibit dispersal of contaminants from the contaminated surfaces. In one embodiment, a lock-down material is applied after source removal and evacuation of contaminants, to prevent dispersal and re-contamination of mold colony on the cavity walls. An air pressure gradient may be established in the cavity 16 to facilitate the dispersal of the lock-down material throughout the cavity. A similar flow circulation system shown in FIG. 2 may be applied to the treatment process herein. Instead of biocide, the content of the reservoir 62 is replaced with the lock-down material, which is introduced into the cavity 16 via the valve 64 by a process similar to the introduction of biocide discussed above.

Biocide may be used first to remove the source at the mold-contaminated region 20 prior to introduction of the lock-down material. In another embodiment, instead of introducing biocide to remove the source at the mold-contaminated region 20, the microwave generator 50 is used to perform source removal.

The lock-down material can be introduced into the cavity 16 in the form of a mist, powder, granule, foam, fog, spray, vapor, gas, liquid or in other suitable phases or formats. Once the mold colony is killed, such as by microwave or biocide, a lock-down material is injected through the hose 32. For example, with microwave application, once the preferred temperature profile is reached that allows sufficient abatement of the mold colony, the microwave generator 50 is switched off to bring the temperature of the cavity 16 down to room temperature. Once room temperature is reached, a lock-down material is injected into the cavity 16. It is carried by the inlet air stream across the mold-contaminated region 20 at room temperature, or at an elevated temperature depending on the particular lock down material applied. The lock down material cures into a protective layer 60 that adheres to the surfaces. Any mold spores and dead mold cells remaining present in the cavity 16 are bonded to the cavity's surfaces by the lock-down material, preventing their escape and negating their potential allergenic effects. Excess lock-down material is drawn through the suction hose 24 by the suction device 28, and removed by a three-stage filter, for example. The circulating air stream facilitates even airflow across the contaminated region 20, resulting in a smoother temperature gradient and better lock-down material distribution. After sufficient lock-down material is applied, the holes 22 and 30 are sealed.

In one embodiment, preferably a non-carcinogenic, organic material, which is based on styrene, butadiene or other substituted ethylene (C═C) monomers, or cyanoacrylic based adhesive, is used as the lock-down material. For example, the styrene based lock-down material may be applied after the mold colony present in the cavity 16 has been abated by application of microwaves as disclosed above in reference to FIG. 1, or biocide as disclosed above in reference to FIG. 2. The styrene-based lock down material is distributed throughout the cavity 16 as a vapor and polymerize over time on the cavity's surfaces. A barrier layer 60 is formed when the styrene polymerizes on the contaminated surfaces, thus, preventing mold spores and mold cells in the structural members from leaving the surfaces and inhibiting external mold spores and mold cells from penetrating the treated surfaces. The rate of polymerization depends in part on the operating temperature, which typically increases with application of heat. For example, the microwave generator 50 can be kept on during the application of lock down material after source removal or other abatement process, to maintain a temperature profile of the cavity 16 that is higher than room temperature and below 200° F. so as to increase the rate of polymerization. For styrene, the rate of polymerization could double with every 10° F. increase in temperature. Once sufficient styrene has been polymerized, inlet and outlet holes 30 and 22 are patched.

Alternatively, source removal and surface treatment may be accomplished in a single step, in which biocide and lock-down materials are applied concurrently, either as separate materials deployed for example in a mixture, or as a single material that is capable to serve both functions.

The treatment process does not need to be deployed immediately after the source removal process. Intermediate steps or processes may be present without departing from the scope and spirit of the present invention. While the treatment process has been described above in conjunction with source removal, in another embodiment, a lock-down material may be applied after evacuation of contaminated air, without source removal, with or without other intermediate steps or processes. It is also contemplated that for certain applications, a lock-down material may be applied without first evacuating the contaminated air from the cavity. Further, the evacuation process and the source removal process may be deployed concurrently with the treatment process, without having to wait for completion of one process to being another.

It is noted that the particular size and location of inlet hole 30 and outlet hole 22 could be chosen depending on the structure of the cavity 16, the flow rate, and the flow pattern of the evacuation, biocide and/or lock down material as applied as disclosed above. In addition, the number of inlet and outlet holes and the relative positions thereof may be selected to obtain a flow pattern that would improve air circulation, facilitate a more thorough air exchange and/or a more uniform dispersal of biocide and/or lock down material within the cavity. For example, one or more inlet holes may be provided at the foot of a dry wall panel, in conjunction with one or more outlets distributed near the top of the wall panel, so that air circulation could be improved within the wall cavity. This approach is particularly useful for biocides and lock down materials that are less dense than air, or that tend to float upwards, e.g., in the form of a foam.

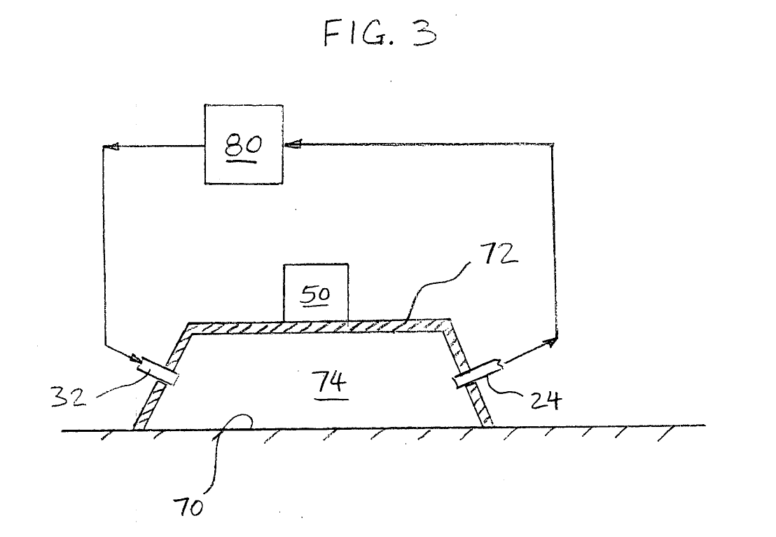

While the inventive processes are described in connection with a closed wall structure, it is within the scope and spirit of the invention that the abatement processes disclosed above are equally applicable to the abatement of an open structure, e.g., a mold-contaminated exterior surface, by modifying the open structure to form a closed structure, such as by forming a closure. Referring to FIG. 3, this can be done, for example, by using a hood 72 to cover an open surface 74 to define a closed cavity 74, wherein one or more air inlets 76 and outlets 78 are provided in the hood 72 to receive inlet hose 32 and outlet hose 24, to facilitate evacuation of contamination from the cavity 74 between the hood 72 and the contaminated surface 70, and the introduction of biocide and/or lock down material into the cavity 74 to treat the contaminated surface 70 in a similar manner as described with respect to the closed wall structure above. Additional components required for the abatement processes are generally represented by box 80, which may include components such as pumps, suction devices, valves, and related plumbing, the details of which may be similar to those components disclosed in connection with FIGS. 1 and 2. A microwave generator 50 may be attached to the hood 72 for source removal in the cavity 74, in a similar manner as described for the earlier embodiments.

While the present invention has been particularly shown and described with reference to the illustrated embodiments, it will be understood by those skilled in the art that various changes in form and detail may be made without departing from the spirit, scope, and teaching of the invention. For example, although the above embodiments disclosed specific implementation of the invention, various components and steps of the disclosed processes can be replaced, removed or combined in different orders to achieve different results without departing from the scope and spirit of the present invention. Accordingly, the disclosed invention is to be considered merely as illustrative and limited in scope only as specified in the appended claims.

1. A method for abating contamination present within a cavity in a structure, comprising at least one of the steps of:
evacuating contaminated air in the cavity in a controlled manner to limit contamination to ambient environment;
removing contaminants from a contaminated surface in the cavity in a substantially non-destructive manner; and
treating the contaminated surface in the cavity to limit spreading of contaminants and re-contamination of treated surface.

2. The method as in claim I, wherein the cavity is partially or completely enclosed by the structure.

3. The method as in claim 2, wherein the structure is at least one of a permanent, semi-permanent and temporary structure.

4. The method as in claim 3, wherein the cavity is defined at least one of within a wall, above a ceiling and below flooring.

5. The method as in claim 1, wherein the evacuating step limits flow of contaminated air into the ambient environment.

6. The method as in claim 5, wherein the evacuating step further comprises the step of removing contaminants from the drawn air.

7. The method as in claim 1, wherein the evacuating step comprises the step of establishing a pressure gradient in the cavity.

8. The method as in claim 7, where the pressure gradient is established by providing one or more inlet openings and one or more outlet openings in the structure in flow communication with the cavity, and drawing air through said one or more outlet openings.

9. The method as in claim 8, wherein the evacuating step further comprises the step of pumping air into the inlet openings to increase airflow through the cavity to flush out the contaminated air present in the cavity.

10. The method as in claim 7, wherein the evacuating step evacuates contaminated air in a closed loop process.

11. The method as in claim 1, wherein the removing step comprises the step of introducing a biocide into the cavity.

12. The method as in claim 11, wherein the removing step further comprises the step of establishing a pressure gradient in the cavity to facilitate dispersal of the biocide in the cavity.

13. The method as in claim 1, wherein the removing step comprises the step of applying high frequency radio wave that is capable of penetrating the structure beyond which the contaminants are present, and that is capable of eradicating contaminants.

14. The method as in claim 13, wherein the high frequency radio wave is of the type capable of heating the contaminants to destroy the contaminants.

15. The method as in claim 14, wherein the high frequency radio wave comprises microwave.

16. The method as in claim 1, wherein the removing step is undertaken in conjunction with the evacuating step.

17. The method as in claim 16, wherein the removing step is undertaken after the evacuating step.

18. The method as in claim 11, wherein the biocide is introduced into the cavity in at least one of a mist, powder, granule, spray, vapor, foam, fog, gas, liquid, and other formats and phases.

19. The method as in claim 11, wherein the biocide comprises an active ingredient that is in at least one of the following categories of materials: (a) oxidizers, (b) surfactants, (c) toxic metal donors, and (d) metabolic toxins.

20. The method as in claim 19, wherein:
the oxidizers include at least one of bromine, N-bromoacetamide, 3-bromo-1-chloro-5,5-dimethylhydantoin, hydrogen peroxide, hypochlorite bleach solution, iodine, N-bromoacetamide, and ozone;
the surfactants include at least one of lauryl pyridinium chloride, quaternary ammonium salts, quaternary ammonium solutions, higher molecular weight alcohol, and d-limonene;
the toxic metal donors include at least one of borax (sodium tetraborate decahydrate), disodium octaborate tetrahydrate, boric acid, calomel (mercurous chloride), copper hydroxide, copper sulfate, maneb, mancozeb, sulfur, and zineb; and
the metabolic poisons include at least one of benomyl, captan, captafol, cyanides, sulfides, and streptomycin. Other substances, compounds and elements falling within the general categories or otherwise compatible could be used, and is well within the scope of the present invention.

21. The method as in claim 20, wherein the biocide contains TIM-BOR® as an active ingredient.

22. The method as in claim 1, wherein the treating step comprises the step of introducing a lock-down material into the cavity.

23. The method as in claim 22, further comprising the step of establishing a pressure gradient the cavity to facilitate the dispersal of the lock-down material in the cavity.

24. The method as in claim 22, wherein the lock-down material provides a barrier on the contaminated surface of the cavity, against dispersal from the contaminated surface and re-contamination of the surface.

25. The method as in claim 22, wherein the lock-down material is introduced into the cavity in at least one of a mist, powder, granule, spray, vapor, foam, gas, fog, liquid, and other formats and phases.

26. The method as in claim 22, wherein the lock-down material includes a material within at least one of the following classes of materials (a) substituted ethylene (C═C) monomers; and (b) cyanoacrylic based adhesive.

27. The method as in claim 26, wherein the substituted ethylene monomers include at least one of styrene and butadiene.

28. The method as in claim 1, wherein the treating step is undertaken in conjunction with the evacuating step.

29. The method as in claim 28, wherein the treating step is undertaken after the evacuating step.

30. The method as in claim 1, wherein the treating step is undertaken in conjunction with the removing step.

31. The method as in claim 30, wherein the treating step is undertaken after the removing step.

32. The method as in claim 1, wherein the treating step is undertaken in conjunction with the evacuating step and the removing step.

33. The method as in claim 32, wherein the treating step is undertaken after the evacuating step and the removing step.

34. The method as in claim 1, wherein the contamination is associated with an undesirable substances.

35. The method as in claim 34, wherein the contamination is associated with a harmful substance that has harmful health effects on humans and/or other living beings.

36. The method as in claim 35, wherein the harmful substance includes a harmful organism that is at least one of a saprophytic organism, a parasitic spore-producing organism, and an organisms that lack chlorophyll.

37. The method as in claim 35, wherein the harmful organism includes at least one of fungus and bacteria.

38. The method as in claim 37, wherein fungus includes at least one of mold, mildew, rust, yeast, mushroom, smut, and any mycotoxin, spore, scent, and byproduct produced and/or released by the fungus.

39. A method for abating contamination of a contaminated surface of an opened structure, comprising the steps of:
modifying the open structure into a closed structure enclosing the contaminated surface, thereby forming a cavity above the contaminated surface; and
abating contamination present within the cavity by applying the method as in claim 1.

40. The method as in claim, wherein the modifying step comprises the step of providing a hood to form the closed structure.

41. A system for abating contamination, comprising:
means for evacuating contaminated air in a controlled manner to limit contamination to ambient environment;
means for removing contaminants from a contaminated surface in a substantially non-destructive manner; and
means for treating the contaminated surface to limit spreading of contaminants and re-contamination of treated surface.

42. The system as in claim 41, wherein the contaminated surface is located in a cavity in a structure.

43. The system as in claim 41, wherein the contaminated surface is a surface of an open structure; and wherein the system further comprises means for modifying the open structure into a closed structure enclosing the contaminated surface, thereby forming a cavity above the contaminated surface.

44. The system as in claim 43, wherein the modifying means comprises a hood structure.
